(19) United States
(12) Patent Application Publication
(10) Pub. No.: US 2025/0096288 A1
(43) Pub. Date: Mar. 20, 2025

(54) FLOWING ELECTROCHEMICAL CELLS

(71) Applicant: Schlumberger Technology Corporation, Sugar Land, TX (US)

(72) Inventors: Andrew Clarke, Cambridge (GB); Adam Colbourne, Cambridge (GB)

(21) Appl. No.: 18/883,675

(22) Filed: Sep. 12, 2024

(30) Foreign Application Priority Data
Sep. 14, 2023 (GB) GB2314047.8

(51) Int. Cl. H01M 8/04186; H01M 4/86; H01M 8/04082; H01M 8/18

(52) U.S. Cl. CPC H01M 8/04186; H01M 4/8626; H01M 8/04201; H01M 8/188

(57) ABSTRACT

An electrochemical cell wherein electrolyte flows through the cell, as in a redox flow battery or a fuel cell, uses electrolyte(s) which are in a state of elastic turbulence in contact with the electrode(s). The elastic turbulence enhances transport of electrochemically reactive species to the surfaces of the electrode(s) and the transport of reaction products away from those surfaces.

### CROSS-REFERENCE TO RELATED APPLICATIONS

The subject disclosure claims priority from GB Application No.: GB 2314047.8, filed on Sep. 14, 2023, herein incorporated by reference in its entirety.

### FIELD

This disclosure relates to flowing electrochemical cells (FECs). These may for instance be included in a flow battery for storing energy, or a fuel cell for generating electricity by electrochemical reaction of a substance consumed as fuel.

### BACKGROUND

Flowing electrochemical cells are used in various categories of equipment. One of these is flow batteries which normally consists of two half-cells separated by a membrane which separates the fluids of the two half-cells but which allows the passage of ions which are required to cross from one half-cell to the other. During charge and discharge, in each half-cell, a fluid containing one or more species which undergo electrochemical reaction is pumped through the half-cell from an associated storage vessel and after passing through the half-cell, is either discharged to another storage vessel or circulated back to the vessel it came from. Flow batteries typically have the characteristic that the storage capacity for electrical energy is not determined by the size of the electrochemical cell but by the amount of fluid which is held in the storage vessels.

Equipment for carrying out an electrochemical reaction may consist of two half-cells in a similar way. Electricity may be consumed to bring about reaction. In a fuel cell a substance which undergoes electrochemical reaction is consumed as fuel for generating electricity which is the output of the fuel cell.

In these various possibilities a flowing electrochemical cell is an electrochemical reactor in which a fluid containing an electroactive chemical species is flowed past or through an electrode material. At the electrode, an electrochemical reaction occurs either spontaneously, or due to an externally applied potential that results in the transfer of one or more electrons from the electrode to the electroactive chemical species, or vice versa. For this process to occur, the electroactive species in solution migrates to the electrode surface, binds or associates with the surface in such a way as to enable the transfer of electrons and subsequently migrate away from the surface. Consequently, the amount of electric current at the electrode is dependent on the amount of the electroactive chemical species at the electrode surface.

It is therefore desirable to have an electrode of high surface area to maximize the rate at which reactions can occur for a given geometrical electrode area (i.e. the area within an outline of the electrode) and also have rapid mass transport, that is to say rapid transport of reactive species and reacted species to and from this electrode surface. However, as the surface area of an electrode is increased for a constant geometrical area, the permeability of the electrode typically decreases, causing a higher pressure-drop across the electrode and requiring more energy to be consumed for fluid circulation. There has to be a compromise between the conflicting requirements of high surface area and low pressure drop as the fluid flows over or through the electrode.

A considerable body of work exists in the creation of structured carbon electrodes for FECs. Commonly applied high-surface area materials include felts, cloths and papers of polymer (synthetic and natural) fibers. These structures are variously woven, precipitated from solution, electro-spun or otherwise made into a porous matrix with a high surface area, before being converted primarily to carbon through “carbonization” in which the majority of non-carbon elements present in an organic material (e.g. H, O and N) are removed, typically at high temperatures under a non-reactive atmosphere.

Designs which use a high surface area porous material can be classified as either “flow through” type in which there is an inlet to the porous material in one place and an outlet from it in another place or “flow-past” type in which the fluid flows across an outer surface of a body of porous material (which may be a thin body) and at least some of the fluid flow diffuses into the porous matrix. A flow-past design may have the advantage of a relatively low resistance to flow, with a largely even distribution of fluid when it is delivered to the porous electrode. However, this comes at the cost of relying on diffusive transport in the direction perpendicular to the channel, and within the porous electrode to facilitate the movement of electroactive species from the channel, to and from the electrode. Electrodes which are entirely flow-through or flow-past represent extremes. There are many flow field designs which are in between.

### SUMMARY OF THE DISCLOSURE

This summary is provided to introduce concepts that will be further elaborated and described below in the detailed description. This summary is not intended to identify key or essential features of the claimed subject matter, nor is it intended to be used as an aid in limiting the scope of the claimed subject matter.

In one aspect this disclosure provides a system comprising an electrochemical half-cell with an electrode in contact with a flow path for a fluid containing a constituent which is able to undergo electrochemical reaction at the electrode, and a pump to propel the fluid along the flow path, wherein the fluid contains a solute enabling the fluid to display elastic turbulence, and the flow path in contact with the electrode is configured to cause changes in the direction of flow, so as to cause elastic turbulence within the flow of fluid in contact with the electrode.

Elastic turbulence enhances the transport of the reactive constituent(s) of the fluid to the electrode and/or enhances transport of produced species from the electrode. This may increase the electrical current density (current per unit area) at the electrode or may reduce overpotential which is required to bring about the transport of reactive species to the electrode surface at a particular rate. Elastic turbulence occurs at flow rates where flow of a Newtonian fluid such as pure water would be laminar and so it is not necessary to pump the fluid at a higher flow rate to achieve flow velocities where inertial turbulence would occur.

The enhanced transport can arise in two ways. Elastic turbulence can transport reactive species to the surface of an electrode and also take reaction product away from the electrode surface more rapidly than by diffusion through the fluid. That is particularly relevant when the fluid is in a state of elastic turbulence within a porous electrode. Secondly, in a flow-by design, elastic turbulence in a channel adjoining a porous electrode will increase the pressure drop along the channel and this will cause more fluid to enter the porous electrode.

The fluid may be a solution in which the constituent able to undergo reaction is a solute. Such a fluid containing an electroactive solute is often referred to as an electrolyte.

In another aspect this disclosure provides a method of operating a flowing electrochemical cell with an electrode in a flow path for a fluid containing a constituent which is able to undergo electrochemical reaction at the electrode, wherein the fluid contains a solute enabling the fluid to display elastic turbulence, the flow path at the electrode causes changes in the direction of fluid flow, and the method comprises pumping the fluid along the flow path with the fluid in a condition of elastic turbulence while it is in contact with the electrode.

A flow path in contact with an electrode may contain obstructions which compel the fluid flow to change direction. In embodiments of this disclosure a flow guide provides an array of spaced obstructions which compel changes in flow direction.

### BRIEF DESCRIPTION OF THE DRAWINGS

Many of the drawings are diagrammatic and are intended to show component parts in relation to each other. Thin components such as membranes are shown with exaggerated thickness to make them and their positions more readily seen.

FIG. 1 is a plot of experimental results showing onset of elastic turbulence.

FIG. 2 is a schematic diagram showing component parts of a flow battery.

FIG. 3 is a view on the line A-A of FIG. 2 showing the path for circulation of electrolyte fluid through a flow-through porous electrode;

FIG. 4 is a diagram showing component parts of another flow battery, with the flow guides and membrane in cross section.

FIG. 5 shows a flow guide as used in the flow battery of FIG. 4.

FIG. 6 is an inside view of one of the flow guides, in the direction B-B of FIG. 4.

FIG. 7 is an enlarged view of part of that flow guide, again in the direction B-B.

FIG. 8 is a similar view to FIG. 7, showing pillars with a different cross section.

FIG. 9 is a diagram showing component parts of a third flow battery, with the flow guides and membrane in cross section.

FIG. 10 shows five of the flow batteries of FIG. 9 connected as a stack.

FIG. 11 is a diagram showing component parts of a fuel cell.

FIG. 12 is a diagrammatic view of apparatus to determine operating parameters for an electrochemical half-cell.

FIGS. 13 and 14 show experimental results obtained with one example of such apparatus.

FIG. 15 is a diagram of apparatus for observing elastic turbulence by means of birefringence.

FIG. 16 shows, in greyscale, pictures obtained with the apparatus of FIG. 15.

### DETAILED DESCRIPTION

This detailed description shows various embodiments of the present disclosure and possibilities which may be used. It should be appreciated that features or possibilities described in combination may, where it is practical to do so, be used separately. Also, features or possibilities described in any embodiment may be used in any other embodiment, in so far as it is possible to do so.

The present disclosure uses the phenomenon of elastic turbulence. It is of course well known that Newtonian fluids such as pure water can undergo either laminar flow or turbulent flow. Such turbulent flow may be referred to as inertial turbulence. Conditions for laminar and turbulent flow are often expressed by Reynolds number which is a ratio of inertial to viscous forces within a fluid. Reynolds number has no dimensions because it is a ratio. At Reynolds number above about 2000 there is inertial turbulent flow. At Reynolds number below about 1500, flow of a Newtonian fluid is laminar. In microfluidic devices, the dimensions of flow paths are very small and flow rates are also very small so that the devices have a volume less than 10 ml and the Reynolds number is vanishingly small, far below one.

Elastic turbulence is different from inertial turbulence. It is a physical phenomenon discovered at the end of the twentieth century. It has been observed at low flow speeds where Reynolds number is low and a Newtonian fluid would be in a state of laminar flow. Some early observations of elastic turbulence used the older term “elastic instability”. However, that term is more general and includes other forms of instability in flow. Literature documents relating to elastic turbulence include a detailed discussion by Steinberg in Annual Review of Fluid Mechanics, vol 53, pages 27-58 (2021).

Methods and systems embodying the present disclosure may use equipment with dimensions and flow speeds such that flow arriving at a half-cell is laminar, and may have a Reynolds number of at least 1 but below 1000 and possibly below 500 or 250. Where it is possible to estimate Reynolds number for flow in contact with an electrode, it may again be between 1 and 1000 and possibly below 500 or 250.

Elastic turbulence occurs in solutions containing a solute which has a flexible structure. One category of material able to undergo elastic deformation and enable a solution to display elastic turbulence is a polymer containing long flexible linear chains. The number of monomer units in the polymer may be at least 5000 and may be considerably more such as at least 25,000. The monomer units may be present in linear chains of at least 1000 monomer units which may each be connected one to the next by a single covalent bond, so that one monomer unit can rotate relative to adjoining monomer units. Individual linear chains may be longer and a polymer may contain a linear chain of at least 5000 or even at least 10,000 monomer units. A polymer chain may contain only one kind of monomer or the chain may be a copolymer of more than one monomer, for instance a block copolymer which is linear. A polymer may also include side chains attached to a long chain of monomer units which are connected together by single covalent bonds. If a chain contains units which are themselves an oligomer, as in a block copolymer for instance, the oligomeric units may rotate relative to one another more freely than monomer residues within an oligomeric unit. A polymer may include some chain branching, for instance at branch points where three or more linear chains, each of at least 1000 monomer units, are connected together. When using a long chain polymer to enable elastic turbulence to occur, it is desirable to include a biocide to protect the long chain linear polymer from biodegradation

The flexibility of the polymer chains enables the polymer molecules to become entangled. The flexibility of polymer chains can be described by means of a mathematical model. The freely jointed chain model is commonly used and the flexibility of a particular polymer can be indicated by parameters of an equivalent freely jointed chain (itself a mathematical model). A description of this approach is provided by Chapter 2 of “Polymer Physics” by Rubinstein and Colby, 2003, Oxford University Press. An equivalent freely jointed chain has the same mean-square end-to-end distance and the same maximum end-to-end distance as the actual polymer but is considered to consist of so-called Kuhn monomers which are freely rotatable relative to each other. These model monomers have a length, termed the Kuhn length, and a molar mass.

Polymers to enable elastic turbulence may contain at least one flexible polymer chain with length and composition represented by at least 5000 Kuhn monomers having a Kuhn length not more than 100 Angstroms (10 nm) and possibly not more than 50 Angstrom. If a polymer is a single unbranched chain, its length and composition may correspond to at least 20,000 Kuhn monomers and possibly at least 50,000 Kuhn monomers.

The mean molecular weight of the polymer may be at least one Mega Dalton i.e. at least 100 Daltons, possibly at least 10 Mega Daltons or more. The concentration of such long chain/high molecular weight polymer included in a solution for enabling elastic turbulence to occur may be under 5% by weight, for instance in a range from 0.05% or 0.1% up to 1% or 2% by weight.

Elastic turbulence has been observed with several different long chain polymers in solution. One such polymer is polyacrylamide, which may be hydrolyzed or partially hydrolyzed. Experimental evidence for elastic turbulence in a solution of high molecular weight polyacrylamide was given by Groisman and Steinberg in “Elastic Turbulence in a polymer solution flow” Nature, Vol 45 page 53 (2000). Other instances of long chain polymers reported to give rise to elastic turbulence include polyisobutylene of molecular weight 4 to 6 Megadaltons dissolved in an organic solvent (Dris and Shaqfeh, J. Non-Newtonian Fluid Mech. Vol 80 pages 1 to 58 (1998)), polystyrene of molecular weight 18 Megadaltons in an organic solvent (Magda and Larson, J. Non-Newtonian Fluid Mech. Vol 30 pages 1-19 (1988)) and polyethylene oxide of molecular weight 4 MegaDaltons in an aqueous solution (Davoodi et al, J. Fluid Mech. Vol 857, pages 823-850 (2018)). Kuhn lengths for polystyrene and polyethylene oxide given by Rubinstein and Colby, page 53 are 18 Angstroms and 11 Angstroms. Kuhn length for polyacrylamides has been reported as 15 to 25 Angstroms (Fetters, Lohse and Colby, Chain Dimensions and Entanglement Spacings. In Physical Properties of Polymers Handbook; Mark, J. E., Ed.; Springer: New York, 2007; pages 447-454).

Long chain partially hydrolyzed polyacrylamide linear polymers with a molecular weight of more than 1 MegaDalton are available from SNF Floerger, whose headquarters are in Andrézieux, France.

Elastic turbulence has also been observed with solutions containing a surfactant which forms worm-like micelles in solution. There is extensive scientific literature concerning surfactants which form worm-like micelles, their properties and applications. One review is Yang “Viscoelastic wormlike micelles and their applications” Current Opinion in Colloid & Interface Science vol 7 pages 276-281 (2002). Discussions of properties include Raghavan and Kaler “Highly Viscoelastic Wormlike Micellar Solutions Formed by Cationic Surfactants with Long Unsaturated Tails” Langmuir vol 17, pages 300-306 (2001) and Beaumont et al “Turbulent flows in highly elastic wormlike micelles” Soft Matter vol 9 page 735 (2013). An example, using cetyl trimethyl bromide as the surfactant, is mentioned by Favolin et al in Physical Review Letters Vol 104 178303 (2010).

The ability of a fluid composition to display elastic turbulence can be shown experimentally using a laboratory rheometer. In a cone and plate rheometer cell, the onset of elastic instability with application of increasing shear is observed as an apparent increase in viscosity at a particular shear rate associated with an abrupt increase in the noise in the measured torque signal. This has been described by D. O. Olagunju, “Instabilities and bifurcations of von Karman similarity solutions in swirling viscoelastic flow” in Z Angew Math Phys, 46 (1995) 224-238 and also by E. Tran, A. Clarke, “The relaxation time of entangled HPAM solutions in flow”, Journal of Non-Newtonian Fluid Mechanics, 311 (2023) 104954.). The apparent increase in viscosity can be seen as a change in the slope (sometimes referred to as an uptick) in the plot of viscosity against shear rate.

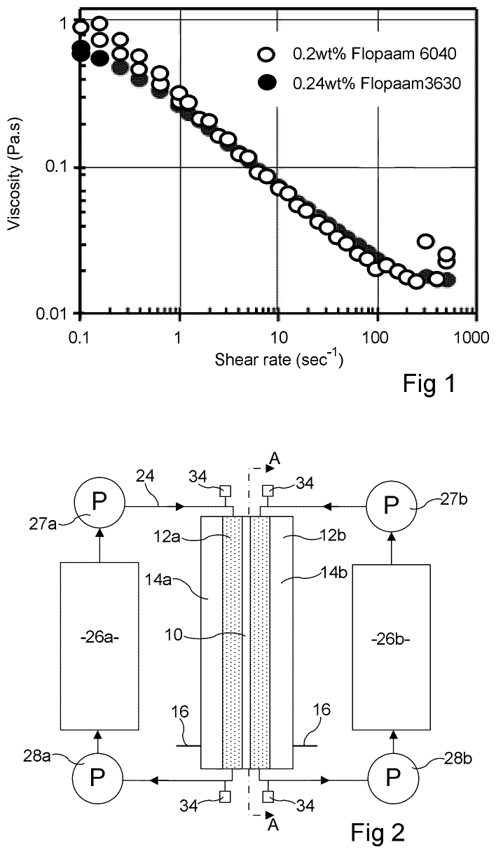

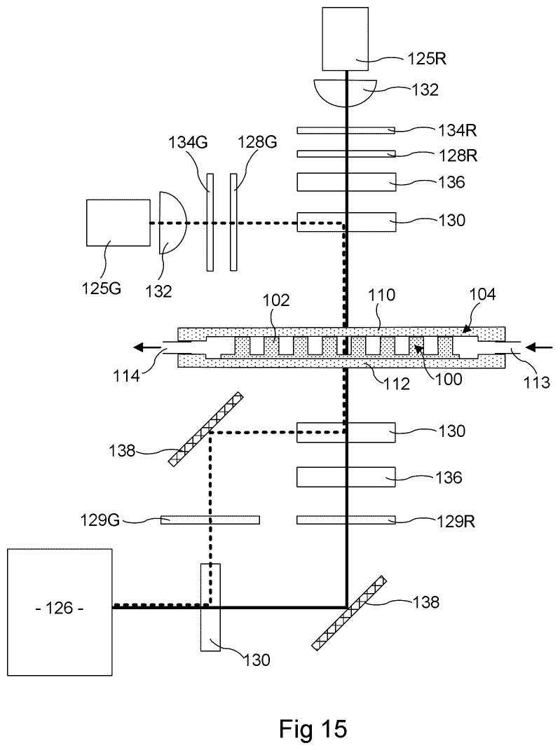

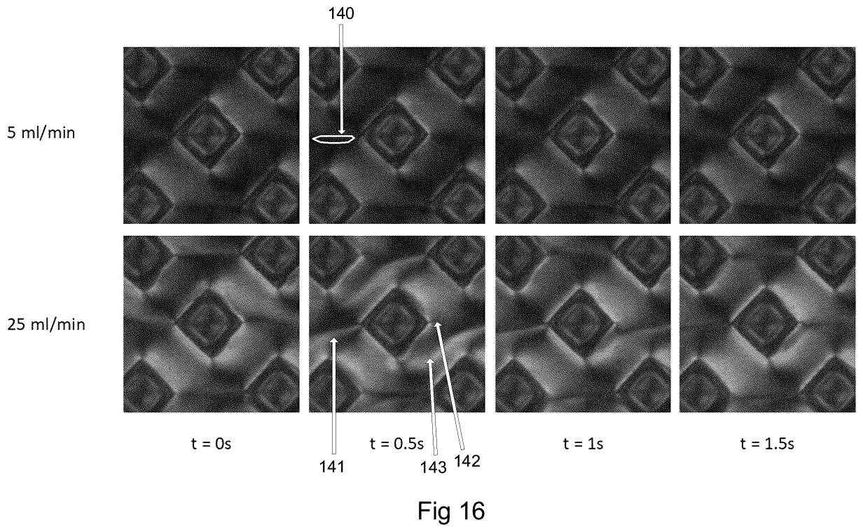

FIG. 1 shows results from experimental tests carried out with a laboratory rheometer operated to take measurements at increasing steps in shear rate and then at decreasing steps. It is a plot of dynamic viscosity against increasing shear rate for two aqueous solutions containing 0.456 wt % sodium chloride, a small percentage of a linear polyacrylamide with molecular weight above 10 MegaDaltons and a few drops of a biocide consisting of isopropanol and thiourea. In one of these aqueous solutions the polyacrylamide was 0.24 wt % of Flopaam 3630 from SNF Floerger which has mean molecular weight of 18 to 20 MegaDaltons. In the other aqueous solution the polyacrylamide was 0.2 wt % of Flopaam 6040, also from SNF Floerger, with a mean molecular weight between 25 and 30 MegaDaltons. For both solutions, the onset of elastic turbulence with increasing shear rate can be seen as the change in slope of the plotted curve. It is seen at approximately 150 s⁻¹. (Shear rates in contact with an electrode, in embodiments of this invention, may be lower). Additional experimental work showing elastic turbulence in polymer solution and in a solution of viscoelastic surfactant is described below with reference to FIGS. 15 and 16.

When a solution contains a substance able to cause elastic turbulence, the phenomenon of elastic turbulence occurs if the solution is flowing at a sufficient flow velocity (which may be a low velocity) and the path of flow causes the streamlines of the flow to curve. Consequently, one known possibility for a flow path which induces elastic turbulence is a serpentine channel. Other possibilities are mentioned below with reference to the drawings.

The present disclosure applies the phenomenon of elastic turbulence to electrochemical cells. Various possibilities for electrochemical cells are set out in the following description with reference to FIG. 2 onwards. It is common practice to assemble a considerable number of electrochemical cells one next to another in a so-called stack. For the purpose of explanation FIGS. 2 to 9 show single cells comprising two half-cells. However, cells such as those shown may, within the scope of this disclosure, be assembled together as a stack.

In some embodiments a flow path which is in contact with an electrode and in which elastic turbulence occurs is formed by pores within a porous electrode or by the openings between fibers in an electrode made of fibrous material. Such a flow path will incorporate changes of direction which will cause the flow streamlines to turn, possibly turn abruptly, and thereby will enable elastic turbulence to occur within the porous electrode.

A development, which may be used in some embodiments of this disclosure, is to use a novel geometry which induces elastic turbulence but gives less resistance to flow. The structure of the half-cell defines a flow channel at the electrode. An array of obstructions in this flow channel cause the stream lines of the flowing fluid to repeatedly change direction. The lower flow resistance may allow a reduction in the energy needed to pump the fluid through the half-cell. In such embodiments the viscosity of the fluid, the flow rate of the fluid and the width of the gaps between obstructions may give a Reynolds number for the flow which is in a range from 1 to 1000 and possibly not more than 500 or 250.

As already mentioned, elastic turbulence at an electrode in a flowing electrochemical cell is beneficial in that it gives mixing within the flow and transports electroactive species to the electrode surface. It also transports reacted species away from the electrode surface. When elastic turbulence increases the rate at which chemical species are transported, it increases the amount of electrochemical reaction which can occur at an electrode surface within a period of time and so increases the flow of electric current. This benefit may be utilized in several ways. Compared to an electrochemical half-cell where there is no elastic turbulence, elastic turbulence could allow increased electric current without an increase in the size of the half-cell. Or it might be decided to design a half-cell with reduced electrode surface area, yet operating with unchanged maximum electric current. Or the benefit may be a reduced energy requirement for pumping the fluid, for instance by using a smaller pump or pumps for a desired electric current flow. Or the benefit of promoting transport may be a reduction in the overpotential applied to electrodes to promote diffusion of charged reactive species to an electrode by electrostatic attraction.

Adding a long chain high molecular weight polymer to the fluid will increase the viscosity of the solution, although the increase may be small. That increase in viscosity will call for an increase in energy needed to pump the fluid through the half-cell, but this may be more than offset by the increased rate of transport to the electrode surface and so give an improved ratio between electric current at the battery and power used for pumping.

The occurrence of elastic turbulence may be inferred from the electric current flowing into or from an electrochemical cell. The onset of elastic turbulence as flow rate is increased may also be observed as a change in the pressure drop between inlet and outlet of the flow path. Elastic turbulence can also be observed directly if the path of flow is visible through a window and small particles are suspended in the fluid which is flowing. Such visual observations have been reported by Qin et al. Physical Review Fluids vol 2 083302 (2017) and by Groisman and Steinberg, New Journal of Physics vol 6 page 29 (2009).

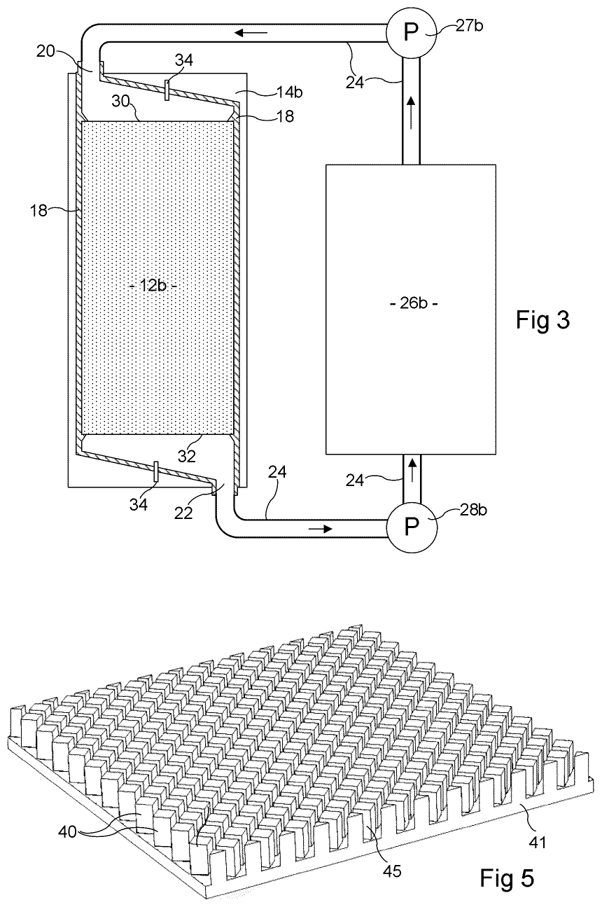

FIGS. 2 and 3 show a flow battery of a conventional form. It has a central membrane 10, which separates two half-cells, and is shown with exaggerated thickness in FIG. 2. Shown to the left of the membrane 10 is a half-cell formed by a porous carbon electrode 12a which is held in contact with the membrane 10 by a rigid plate 14a made of conductive material, such as graphite or a metal. Shown to the right of the membrane 10 is another half-cell formed by a porous electrode 12b held in contact with the membrane 10 by electrically conductive rigid plate 14b. The porous electrodes 12a and 12b may be identical. The plates 14a and 14b may also be identical to each other. Each electrode 12 is made from a fibrous material which has been carbonized, so that it contains numerous carbon strands packed together and has high surface area. The membrane 10, the electrodes 12 and the plates 14 are enclosed by a casing, not shown. Electrical connection to the electrodes 12 is provided by the conductive plates 14 which are themselves connected to electric cables 16.

As shown by FIG. 3, the electrode 12b is surrounded by a frame 18 which has a fluid inlet 20 and a fluid outlet 22. In this view the plate 14b is behind the electrode 12b and frame 18. The plate 14b projects slightly beyond the frame 18, as shown and the frame is sealed to the plate 14b. The electrode 12a is surrounded by a similar frame.

The inlet 20 and outlet 22 of the frame 18 are connected by piping 24 to a storage tank 26b of an electrolyte fluid which is circulated through the electrode 12b by pumps 27b, 28b during charge and during discharge. Similarly, the frame around the porous electrode 12a is connected by piping to a storage tank 26a of an electrolyte fluid which is circulated through the electrode 12a by pumps 27a. 28a. It is desirable to construct the piping 24 without sharp bends or other features which can cause a pressure drop. Fluid pumped to the inlet 20 enters the porous electrode 12b through its end 30 and flows through the electrode 12b to its opposite end 32 from which it continues to the outlet 22 and then onwards through piping 24 to pump 28b and the storage tank 26b. Flow from tank 26a passes through porous electrode 12a in similar manner.

In accordance with this disclosure, the electrolyte fluids flowing through each of the half-cells includes a solute which is a high molecular weight linear polymer able to undergo elastic deformation. The fluids also contained a small amount of a biocide to prevent biological degradation of the polymer. Pumping power is chosen such that flow arriving at the ends 30 of the porous electrodes is laminar. When the flow enters an electrode the mesh of carbonized fibers which form that porous electrode will cause the streamlines of the flow to change direction many times and thereby create elastic turbulence which will mix the electrolyte as it flows, transport the electrochemically active species into contact with the surfaces of carbon in the porous electrode and transport the products of reaction away from the carbon surfaces. The increased transport of chemical species as a result of elastic turbulence will increase the maximum current flow in the half-cell, compared with a half-cell of the same construction but without the polymer in the electrolyte fluid.

Pressure sensors 34 are fitted near to the ends 30 and 32 of the porous electrodes. These allow measurement of the pressure drop between inlet and outlet of an electrode. This measurement of pressure drop can be used to detect the onset of elastic turbulence by pumping fluid at progressively increasing flow rates until there is a sudden increase in the pressure drop at the onset of elastic turbulence.

A very considerable number of compounds able to undergo electrochemical redox reaction have been suggested for use in flow batteries and this is still a subject of research. A number of these compounds have been reported to be usable under mild conditions with neutral or near-neutral pH. By way of example, a possibility for the fluid at a positive electrode is an aqueous solution of iodine and an iodide which can reversibly form tri-iodide ions in the reaction:

2e⁻+I₂+I⁻ [symbol] I₃⁻

A possibility for the fluid at the negative electrode is an aqueous solution of 2,6-dihydroanthraquinone which can undergo electrochemical reduction to the corresponding

hydroquinone. Also, derivatives obtained by reaction of the hydroxyl groups have been suggested in a number of articles including Kerr et al, ACS Energy Letters vol 8 pages 600-607 (203) and Jin et al ACS Energy Letters vol 4 pages 1342-48 (2019).

The concentration of the polyacrylamide required to enable a proposed electrolyte fluid to display elastic turbulence can be found by experiment as described above using a cone and plate rheometer cell to obtain plots of viscosity against shear rate for samples of electrolyte fluid, containing varying amounts of polyacrylamide, for instance starting with 0.5 wt % and increasing until clastic turbulence is detected.

Further possibilities for electrochemically reactive species are other quinones, ferrocenes and bipyridyl compounds. The latter are also known as viologens. DeBruler et al in ACS Energy Letters vol 3 pages 663-668 (2018) have described an experimental flow battery in which one half-cell contained 1,1′-bis[2-sulfonatopropyl]-4,4′-bipyridinium and the other half-cell contained iodine and iodide as above. The separating membrane was a cation exchange membrane. Another experimental flow battery for the electrochemistry using an anion exchange separating membrane, a substituted viologen in one half-cell and a substituted ferrocene in the other has been described by Lv et al in ACS Energy Letters vol 7 pages 2428-2434 (2022).

Published literature has also suggested electrochemically reactive species which are large polyoxometalate complexes, see for instance Wang et al J.A.C.S vol 134 pages 4918-4924 (2012) or are redox active polymers, see for example Burgess et al Acc. Chem. Res, vol 49 pages 2649-2657 (2016). These possibilities offer advantages, but diffusion of these species through a liquid electrolyte is slow because of their size. Such systems may be improved by utilising elastic turbulence in accordance with the present disclosure.

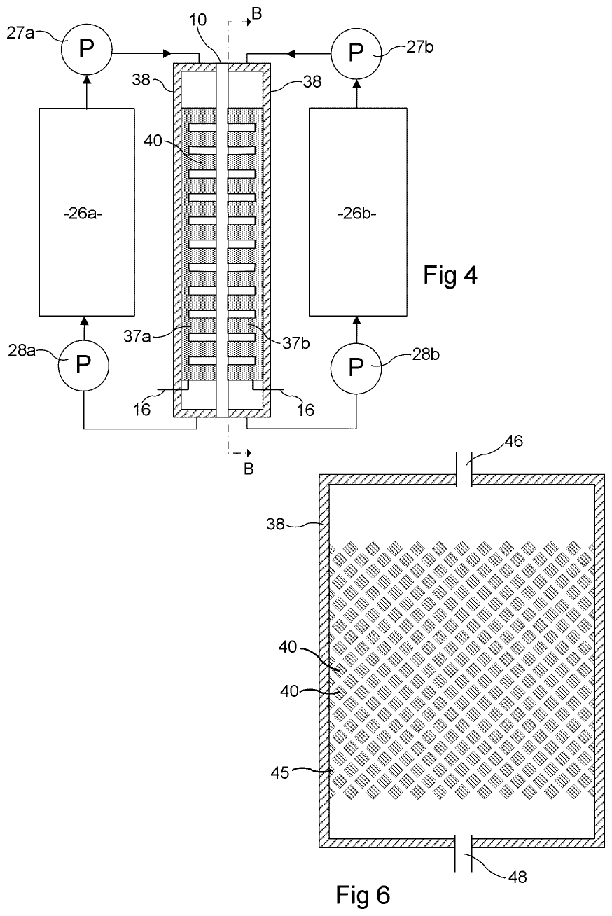

FIGS. 4 to 7 show a flow battery which is different in construction to that of FIGS. 2 and 3. The battery again has two half-cells separated by a membrane 10 which is shown with exaggerated thickness in FIG. 4. Each half-cell has a rigid flow guide next to the membrane 10. The flow guides are held in position by a casing 38 of the flow battery. As shown by FIG. 5, each flow guide has an array of pillars 40 integral with a base 41. Each flow guide is made from conductive material, such as graphite and also serves as the electrode of the half-cell.

Electrolyte fluids from tanks 26a and 26b are pumped through the half-cells by pumps 27a, 27b and then returned to the same tanks by the pumps 28a and 28b. In each half-cell the fluid flows through the gaps between the pillars 40 of the flow guide. The electrolyte fluids contain long chain linear polymer as discussed above which enables elastic turbulence to occur.

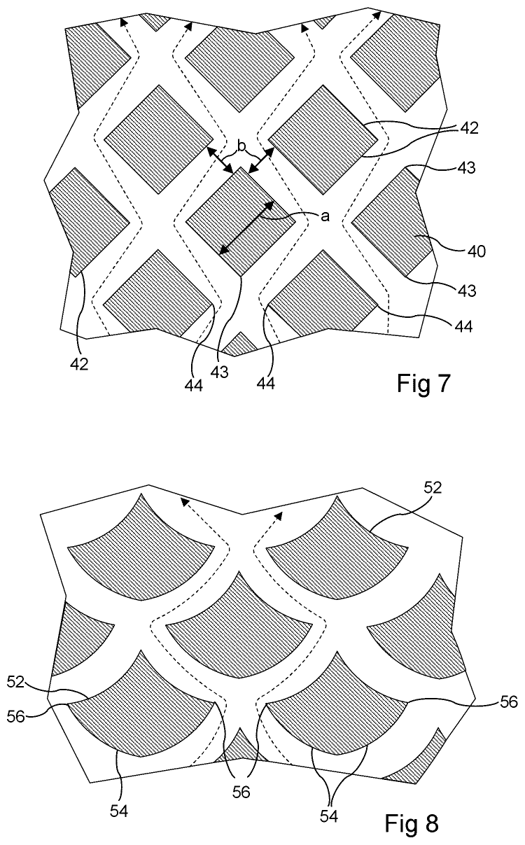

The pillars 40 seen in FIG. 5 are in a regular spaced array also shown by FIG. 6 which is a cross section on line B-B of FIG. 4 and by the enlargement which is FIG. 7. As shown, the pillars 40 have a square cross section with flat faces 42 meeting at corner edges 43 and 44. The width of a flat face 42 is indicated as “a” in FIG. 7 and the spacing between the faces 42 of adjacent pillars is indicated as “b”. The width of the gap between two confronting edges 44 is given by Pythagoras theorem as √2b². As shown in FIG. 5, the edges of the array are completed with pillars 45 which have a triangular cross section. Each pillar 40 is positioned so that the diagonal across the square cross section between corner edges 43 is aligned with the overall direction of flow, i.e. this diagonal is aligned parallel to an imaginary line from the inlet 46 to the outlet 48. Hence the flat faces 42 of each pillar 40 are inclined to this overall direction of flow.

As shown by the enlarged view in FIG. 7, electrolyte fluid flows through the gaps between confronting edges 44 of adjacent pillars 40, but is then compelled to turn by another pillar. Thus the array of pillars 40 obstructs straight line flow of electrolyte fluid, causing the streamlines of the flow indicated with broken lines in FIG. 7 to bend repeatedly. The circulating pumps propel the electrolyte fluids at a flow rates such that flow entering each half-cell at its inlet 46 is laminar but the flow speeds through the arrays of pillars are sufficient to initiate and maintain elastic turbulence in the flow guides as the electrolyte flow through them thereby transporting reactive electrochemical species to the carbon surfaces and the adjacent membrane 10 and so enhancing the current density which can be achieved. This may require less pump pressure than would be needed with high surface area porous electrodes such as in FIGS. 2 and 3.

FIG. 8 shows another possible cross section for pillars 40. The surfaces 54 have convex curvature and intersect concave surfaces 52 at edges 56. Electrolyte fluid flows through the gaps between edges 56 as shown by the broken lines and is compelled by the arrangement of pillars to change direction as it does so.

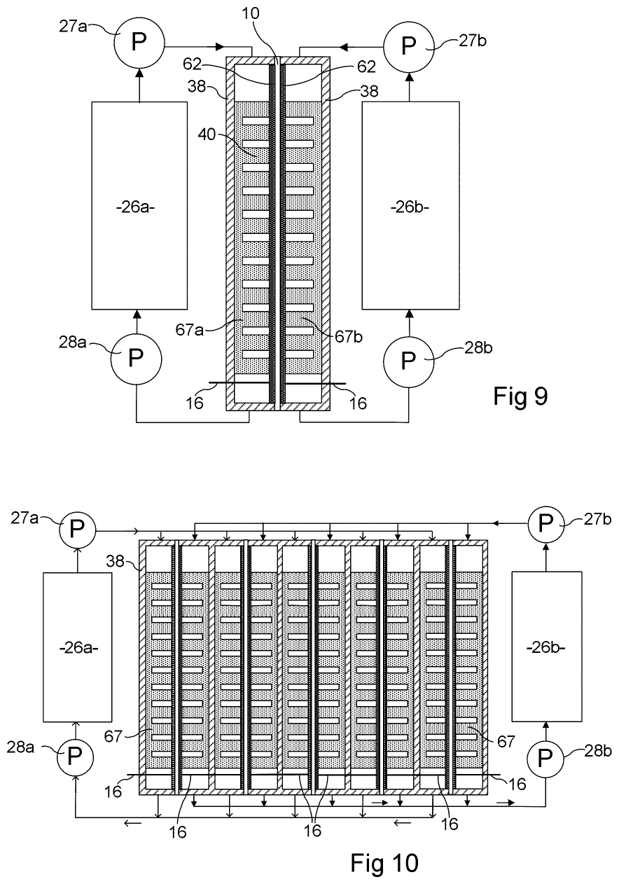

FIG. 9 shows an embodiment with flow guides having the same geometrical features as the flow guide shown in FIGS. 4 to 7. Each of these is not directly abutting the separator membrane 10 but instead abuts a thin porous electrode 62. This arrangement could be used when the electrochemical reaction is not taking place on a carbon electrode but requires an electrode with a catalyst on its surfaces. The electrolyte fluids will be in a state of elastic turbulence when they come into contact with and enter the electrodes 62. Because the electrodes are thin the elastic turbulence may persist while the electrolyte fluids flow through the electrodes and reach the separator membrane 10.

In the arrangement shown by FIG. 9 the flow guides maybe made of graphite or another conductive material in order to conduct electricity from or to the thin electrodes 62. However, if the thin electrodes 62 have sufficient electrical conductivity, the flow guides could be made of an electrically insulating material. They could be made by an additive manufacturing process such as 3D printing.

FIG. 10 shows five of the electrochemical cells arranged side by side in a so-called stack. The cells are shown connected electrically in series by cable 16, although connection in parallel is also possible. The tank 26a and pump 27a are connected to pump an electrolyte fluid into the left hand half of each cell. Likewise, the tank 26b and pump 27b are connected to pump the other electrolyte fluid through the right hand half of each cell in the stack.

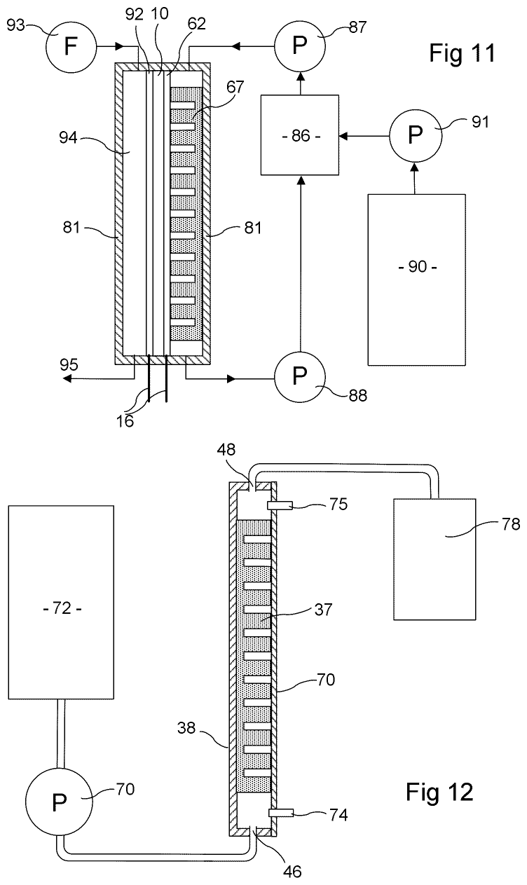

FIG. 11 shows a further embodiment of this disclosure which is a fuel cell using methanol as fuel. It has a membrane 10 separating two half-cells within a casing. At one side, to the right, a thin porous electrode 62 is adjacent to the membrane 10. A flow guide, as described above, is next to this porous electrode 62. The electrode 62 incorporates a catalyst for the electrochemical reaction of methanol. Electrical connections for the generated electricity are indicated at 16.

Electrolyte fluid which is an aqueous solution of methanol containing a solute which is a long chain high molecular weight linear polymer such as Flopaam 3630 or Flopaam 6040 is drawn from mixing tank 86 by pump 87 and pumped into the flow guide 67. Inside the flow guide, the flow around the pillars 40 causes elastic turbulence, as described with reference to FIGS. 4 to 7 and this increases the transport of methanol to the thin catalytic electrode 62. The electrolyte fluid, with a depleted concentration of methanol flows out of the guide 67 and is returned to the mixing tank 86 by pump 88. Additional methanol is drawn from fuel tank 90 and delivered to the mixing tank 86 by pump 91 to maintain a steady concentration of methanol in the mixing tank and so in the fluid entering the flow guide 67.

In the half-cell to the left, atmospheric oxygen combines with hydrogen ions which pass through the membrane 10. A thin porous electrode 92 next to the membrane 10 incorporates a catalyst for this electrochemical reaction. A fan 93 blows air into a plate 94, which has a system of channels 95 cut into it and which gives a distributed flow of air into the catalytic electrode. Wet air with a depleted oxygen content leaves as exhaust.

With embodiments as described above, a flow rate through a half-cell sufficient to cause elastic turbulence can be determined experimentally by observing pressure drop between the inlet and outlet of the half-cell as flow rate is increased. This could be achieved using one half-cell, or a model of one. FIG. 12 illustrates this with one of the half-cells of FIG. 4. The membrane 10 is not present. Instead, a plate 70 is fitted against the pillars 40 of the flow guide 37. Pressure sensors 74, 75 are fitted at the inlet and outlet regions of the fluid path through the flow guide 37. The inlet 46 is connected to a pump 70 which delivers fluid from a tank 72 which is maintained at a fixed temperature. This fluid should be the same as the fluid which will flow through the half-cell when it is in the flow battery. The outlet 48 is connected to a graduated vessel 78 for measuring volume of liquid which has been pumped through the flow guide 37 in a chosen interval of time, and thereby determining the flow rate.

When liquid from the tank 72 is pumped through the half-cell there will be a pressure drop between the inlet pressure sensor and the outlet pressure sensor. When the flow rate is very low, the flow will be laminar, without any elastic turbulence. The minimum flow rate to cause elastic turbulence in the half-cell can be found by progressively increasing the pump speed to increase the flow rate and plotting the pressure drop against flow rate or plotting the pump speed, which is indicative of pressure drop, against flow rate. This plot will show a change in slope on reaching the flow rate at which elastic turbulence begins.

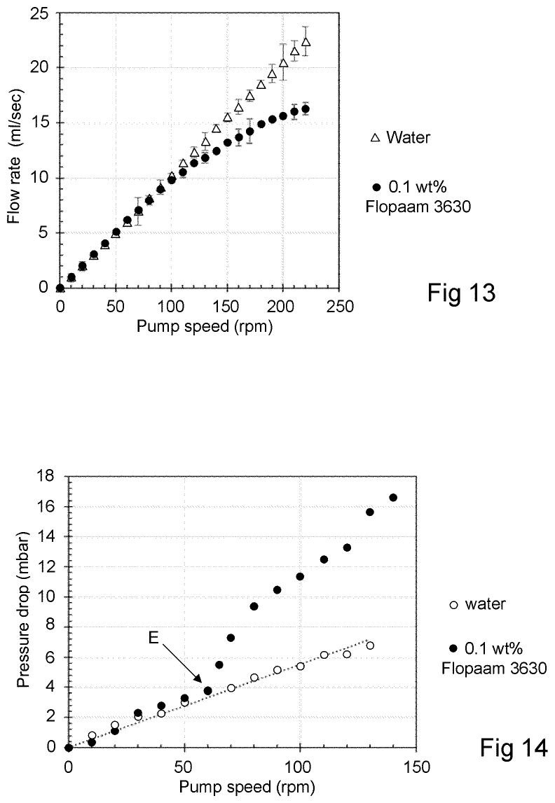

This is illustrated by the following description of experimental work with apparatus similar to that shown. The results of the experiments are shown in FIGS. 13 and 14. An initial calibration determined relationships between pump speed and flow rate. The tank 72 was filled with water. The pump was used to propel water through the half-cell at progressively increasing flow rate. The pump speeds and the flow rates measured downstream of the half-cell were recorded and are shown in FIG. 13 (triangle points). This calibration procedure was then repeated with an aqueous solution containing 0.1 wt % of Flopaam 3630 polyacrylamide in the tank 72. This gave the non-linear plot also shown in FIG. 13 (circular points).

FIG. 14 shows the measured pressure drops plotted against flow rate. With water the plot was approximately linear (as would be expected because water is a Newtonian fluid) but with the polyacrylamide solution there was a very sharp change in the slope of the plot at the point 8, indicating that the flow rate at this point was the minimum required to cause elastic turbulence with that polyacrylamide solution and apparatus.

Measurements of this kind make it possible to estimate Reynolds number for flow through a flow guide. The formula which may be used to determine Reynolds number (Re) for flow through a chamber containing obstructions so as to compel the flow streamlines to bend is:

$$Re = \frac{ρ UL}{η}$$

where p is density of the fluid in Kg per cubic metre,
U is the flow velocity in metres per second,
L is the width of the gaps between the obstructions in the chamber, and
n is the viscosity of the fluid in Pascal·sec.

If the flow rate is measured as volume in unit time, the formula above becomes:

$$Re = \frac{ρ QL}{η A}$$

where Q is the flow rate in cubic meters per second and A is the cross sectional area, transverse to the overall direction of flow, through which the flow passes.

In an example of the flow guide shown in FIG. 5, the flat faces of the pillars had a width “a” of 4 mm and the height of the pillars was 7 mm. The spacing “b” between the faces of adjacent pillars was 2 mm and so the gaps between adjacent edges was V8=2.83 mm. A full line of pillars transverse to the overall direction of flow contained 12 pillars with 11 gaps between edges, and so the cross section available for flow was:

$$11 \times 7 \times 2.83 {mm}^{2} = 11 \times {7.1}^{- 3} \times 2.83 {\text{.10}}^{- 3} {m}^{2} .$$

Flow rate was measured as 75 ml·sec-1=7.5×10⁻⁵ m3 sec-1. Density of the fluid was 1000 kg/m3; viscosity was 0.008 Pa·sec. Putting these numbers into the formula mentioned above

$$Re = \frac{ρ QL}{η A} = \frac{1000 \times 7.5 {\text{.10}}^{- 5} \times 2.83 {\text{.10}}^{- 3}}{{8.1}^{- 3} \times 11 \times {7.1}^{- 3} \times 2.83 {\text{.10}}^{- 3}}$$

which is Re=12.17.

Further demonstrations of elastic turbulence, both when caused by viscoelastic surfactant and when caused by high molecular weight polymer, were carried out using apparatus as shown schematically in FIG. 15. The apparatus included a flow guide 100 having a regularly spaced array of pillars 102 of square cross section integral with a base in similar manner to the flow guide shown in FIG. 5 but with a smaller number of pillars. This flow guide 100 was made of transparent polymer and was located within a surrounding chamber 104 as shown in cross section in FIG. 15. The chamber 104 was formed by two blocks of transparent polymer, 110, 112 held together by bolts which are not shown. The flow guide 100 was in a cavity between the two blocks. There was a liquid inlet 113 to the cavity and a liquid outlet 114. When liquid was pumped through the chamber 104, it flowed through the gaps between the pillars 110. These compelled repeated changes in direction of flow as the liquid flowed through the gaps between pillars (as illustrated by FIG. 7 referred to above) which caused elastic turbulence to occur if the liquid contained a substance able to display elastic turbulence and the flow velocity was sufficient.

The apparatus shown by FIG. 15 enabled the occurrence of elastic turbulence to be observed utilizing the phenomenon of birefringence. The apparatus has some similarity to apparatus described by Moss GR and Rothstein JP in “Flow of wormlike micelle solutions through a periodic array of cylinders”. Journal of Non-Newtonian Liquid Mechanics, Vol 165 pages 1-13, 2010.

Beams from a red LED light 125R and a green LED light 125G were directed along paths, respectively shown as a solid line and as a broken line, towards a video camera 126. The chamber 104 was positioned between linear polarizing filters 128R, 129R set with their polarization directions at right angles (i.e. crossed) and between linear polarizing filters 128G. 129G which were also set with their polarization directions at right angles to each other. Consequently, no light could reach the video camera 126 unless birefringence in the chamber 104 altered the angle of polarization of light passing through the chamber. The filters 128R and 128G were set with their polarization directions at right angles to each other, so that the planes of polarization of the red and green light entering the chamber were at right angles to each other. Dichroic mirrors 130 which pass the red beam and reflect the green beam were used to merge the red and green beams, then to separate them after they have passed through chamber 104, and subsequently to reunite them before they arrive at the camera 126.

Other parts of the apparatus were mirrors 138, lenses 132, red and green bandpass filters 134G and 134R and dichroic mirrors 136 which were set with a 90° difference in rotation with respect to the red beam path in order to cancel rotation of polarization induced due to Fresnel refraction. Such dichroic mirrors were not needed for the green beam because its polarization was such that no rotation of polarization was induced.

Wormlike micelles formed by viscoelastic surfactants are birefringent. Consequently, when these molecules became aligned by liquid flow within the chamber 104 and were illuminated with polarized red and green light, they changed the plane of polarization of the light thereby allowing some of this light to pass through the filters 129R and 129G to the camera, although this did not occur if the alignment of the micelles coincided with the plane of polarization of the light. Providing two light beams with different planes of polarization as they entered the chamber 104 addressed this issue: any micelles aligned with the red polarization would not be aligned with the green polarization and vice versa. Hence the apparatus was sensitive to polarization alignment in any direction.

When there was flow of a liquid containing wormlike micelles through the chamber, these micelles became aligned through extensional flow as the liquid flowed around the pillars 102 of the flow guide 100, and the birefringence from the aligned micelles could be seen as red or green color in pictures or video recorded by the camera 126.

A first experiment was carried out using a solution similar to one mentioned by Moss and Rothstein in the paper above. This solution contained 100 mM (approx. 4 wt %) of the viscoelastic cationic surfactant cetylpyridinium chloride and 50 mM (approx. 0.8 wt %) of sodium salicylate dissolved in a brine of 100 mM (approx. 0.6 wt %) NaCl in distilled water.

The viscoelastic solution was pumped through the chamber 104 at a low flow rate of 5 ml per minute. The camera 126 recorded video at twenty frames per second for a period of 5 seconds and the recording showed that the pattern of flow around the pillars 102 of the flow guide 110 remained constant. Four pictures from that video recording, at half second intervals, are shown in grayscale as the top row in FIG. 16 and it can be seen that there was negligible change from one picture to the next. The original colored pictures showed a line of red color extending in the flow direction from the downstream corner of each pillar. A white outline has been drawn around one of these as indicated 140 in one picture. These lines of red color remained at the same intensity and in the same position throughout the video recording. The flow rate was then increased to 25 ml/min and video was again recorded for 5 seconds. This video recording of flow at 25 ml/min was very different from that at 5 ml/min. It showed constant movement. Patches of color, showing where extensional flow was aligning micelles, were moving from one position to another and varying in intensity. Four pictures from the video with 25 ml/min flow rate are reproduced in greyscale as the bottom row of FIG. 16. There were a number of changes from each picture to the next. For instance, arrow 141 points to a patch of red color which was present in one picture but absent from the preceding picture and diminished in the two subsequent pictures. At the position 142 there was an area of red color which was not present in the preceding picture and again diminished in the next two pictures. The second picture in the lower row also showed an intense green area 143, which was not present in the first picture and which largely disappeared in the third picture. Thus it could be seen that flow at 5 ml/min was laminar but at 25 ml/min the flow had become turbulent.

Similar experiments were carried out with solutions containing partially hydrolyzed polyacrylamide of average molecular weight 18 MDa (HPAM) to enable the display of elastic turbulence and containing xanthan as an additional thickening agent, and with comparative solutions containing only xanthan (which was too rigid to cause elastic turbulence, as mentioned above). These polymers do not form micelles but do cause birefringence when aligned. Again elastic turbulence was not observed at a flow rate of 5 ml/min but was observed at faster flow rates. Flow rates and observations are given in the following table which also repeats the comments from the above experiment with viscoelastic surfactant.

| Solutes | Flow rate | | Comments concerning pictures |
|---|---|---|---|
| 4 wt % cetyl | 5 | ml/min | Red lines extending downstream from pillars do not |
| pyridinium | | | change position. No changes in overall appearance |
| chloride | 25 | ml/min | Red lines extending downstream from pillars change |
| 0.8 wt % sodium | | | angle relative to flow direction. Green areas appear, |
| salicylate and | | | change position and disappear. |
| 0.6 wt % sodium | | | |
| chloride | | | |
| 0.25 wt % HPAM | 5 | ml/min | Red lines extending downstream from pillars do not |
| and 0.25 wt % | | | change position. Green areas do not change. |
| xanthan | 15 ml/min, | | Movement of red areas extending downstream from |
| | and 30 ml/min | | pillars, prominent green areas appear and change |
| | | | position |
| 0.5 wt % xanthan | 5 ml/min, | | Red and green areas do not change position at any flow |
| | 30 ml/min and | | rate |
| | 40 ml/min | | |
| 0.25 wt % xanthan | 30 | ml/min | Red and green areas do not change position |
| 0.12 wt % HPAM, | 5 | ml/min | Red and green areas do not change position |
| 0.12 wt % xanthan, | 45 | ml/min | Red and green areas change in shape and position |
| 0.465 wt % NaCl | | | |

It is apparent from these comments that the solution containing HPAM and xanthan displayed elastic turbulence at 15 ml·sec and above, but solutions containing xanthan without HPAM did not display elastic turbulence even at 30 ml/min.

The various embodiments of this disclosure which have been set out above are intended to assist understanding of this disclosure, but not to limit in any way the scope of this disclosure as defined by the following claims. It should be appreciated that any features or possibilities described in combination may, where it is practical to do so, be used individually. Also, features or possibilities mentioned in the following claims or described in any embodiment may be used in any other embodiment, in so far as it is practical to do so and in particular where two or more of the following claims are dependent on the same preceding claim, the reader should understand that the present disclosure includes any possible combination of any two or more or all of those dependent claims with each other and with that preceding claim.

1. A system comprising an electrochemical half-cell which comprises:
an electrode;
a fluid containing a constituent able to undergo electrochemical reaction at the electrode;
structure defining a fluid flow path carrying flow of the fluid into contact with the electrode, and at least one pump for propelling the fluid along the flow path, wherein the fluid contains a solute enabling the fluid to display elastic turbulence, and the flow path in contact with the electrode is configured to compel changes in the direction of fluid flow, to cause elastic turbulence within flow of the fluid in contact with the electrode.

2. The system of claim 1, wherein the flow path in contact with the electrode includes obstructions which compel changes in the direction of fluid flow.

3. The system of claim 1, wherein the solute is a linear polymer with a molecular weight of at least 10⁶ Daltons.

4. The system of claim 1, wherein the solute which enables the fluid to display elastic turbulence is a polymer containing at least 5,000 monomer units in one or more linear polymer chains each containing at least 1,000 monomer units, connected one to the next by a single covalent bond so that one monomer unit can rotate relative to adjoining monomer units.

5. The system of claim 4, wherein the polymer contains at least one linear chain of at least 5,000 monomer units connected one to the next by a single covalent bond.

6. The system of claim 4, wherein the polymer is a polyacrylamide or hydrolysed polyacrylamide.

7. The system of claim 1, wherein the electrode comprises a porous material.

8. The system of claim 1, wherein the structure defining the flow path comprises a flow guide which comprises a spaced array of obstructions positioned to compel flow along the path to make changes of direction.

9. The system of claim 8 wherein the flow guide is at least part of an electrode.

10. The system of claim 8 wherein the flow guide is in contact with an electrode.

11. A flow battery for storage of electrical energy comprising at least one system of claim 1 wherein the system further comprises:
at least one storage vessel for the fluid with the at least one pump connected to the at least one storage vessel.

12. A flow battery for storage of electrical energy comprising two systems of claim 1 with the electrodes of the two systems at either side of a membrane which separates the fluids of the two systems but allows passage of selected ions from one half-cell to the other and each system comprises at least one fluid storage vessel with the at least one pump connected to the at least one storage vessel.

13. A fuel cell for electricity generation comprising at least one system of claim 1 and further comprising:
a storage tank for a liquid fuel to undergo electrochemical reaction and means to add fuel from the tank to the fluid.

14. A method of operating a flowing electrochemical half-cell with an electrode in contact with a flow path for a fluid containing a constituent able to undergo electrochemical reaction at the electrode, wherein:
the fluid contains a solute enabling the fluid to display elastic turbulence,
the flow path in contact with the electrode causes changes in the direction of flow, and
the method comprises pumping the fluid along the flow path with the fluid in a condition of elastic turbulence while it is in contact with the electrode.

15. The method of claim 14, wherein the solute which enables the fluid to display elastic turbulence is a polymer.

16. The method of claim 14, wherein the flow path in contact with the electrode includes obstructions to the fluid flow and the fluid flow changes direction as it passes the obstructions.

17. The method of claim 14, wherein the flow path comprises a flow guide which comprises a spaced array of obstructions and the fluid flow changes direction as it passes the obstructions.

18. The method of claim 17, wherein the flow guide is at least part of an electrode.

19. The method of claim 17, wherein the flow guide is in contact with an electrode.

20. The method of claim 17, wherein a viscosity of the fluid, the flow rate of the fluid within the flow guide and the width of the gaps between obstructions gives a Reynolds number (Re) for the flow through the flow guide which is in a range from 1 to 1000.
